(19) United States
(12) Patent Application Publication
(10) Pub. No.: US 2022/0205408 A1
(43) Pub. Date: Jun. 30, 2022

(54) GALLERY-COOLED PISTON WITH A FUNNEL-SHAPED INLET INTO THE COOLING GALLERY

(71) Applicant: KS Kolbenschmidt GmbH, Neckarsulm (DE)

(72) Inventors: Patrick Gerd Schwarz, Neckarsulm (DE); Tobias Ziegler, Ilsfeld (DE); Axel Hemsing, Dusseldorf (DE)

(21) Appl. No.: 17/601,475

(22) PCT Filed: Apr. 8, 2020
(86) PCT No.: PCT/EP2020/059975

§ 371 Date: Oct. 5, 2021

(30) Foreign Application Priority Data
Apr. 9, 2019 (DE) 10 2019 109 277.9

(51) Int. Cl. F02F 3/22

(52) U.S. Cl. CPC F02F 3/22

(57) ABSTRACT

A gallery-cooled piston with a cooling gallery or a cooling chamber in the region of the piston crown of the gallery-cooled piston. At least one opening having a funnel-shaped inlet is provided from an inner region of the gallery-cooled piston to the cooling gallery or the cooling chamber. A funnel-shaped tube is inserted into and fixed in the at least one opening after the production of the gallery-cooled piston.

### CROSS-REFERENCE TO RELATED APPLICATIONS

This application is filed under 35 USC 371 and claims priority benefit to PCT patent application PCT/EP2020/059975 filed Apr. 8, 2020, which claims priority to and the benefit of German patent application no. 10 2019 109 277.9 filed Apr. 9, 2019, the entire contents of both application incorporated herein by reference.

### TECHNICAL FIELD

The invention relates to pistons for use in internal combustion engines.

### BACKGROUND

Devices for realizing a ring-shaped cooling gallery are known from DE 100 15 709 A1 or DE 102 34 539 A1. In both cases, the ring-shaped cooling gallery is produced as a separate component prior to production of the piston blank, which is to be cast, and inserted in the mold prior to casting. The separate component in this case has an extremely complex form, giving rise to the risk firstly of said component being damaged during the handling involved in inserting it in the mold, or secondly of it even being forgotten

### SUMMARY

The invention relates to a gallery-cooled piston with a cooling gallery, or a cooling chamber, in the region of the piston crown of the gallery-cooled piston, and also to a method for producing a gallery-cooled piston of this kind, wherein at least one opening from an inner region of the gallery-cooled piston to the cooling gallery, or the cooling chamber, is provided with a funnel-shaped inlet.

A gallery-cooled piston of this kind has at least one cooling gallery (or at least one cooling chamber) in its upper region (piston crown), into which a medium is inserted or introduced, circulated, and removed again, in order to cool this upper region of the gallery-cooled piston which faces the combustion chamber of the internal combustion engine. The medium is usually oil from the internal combustion engine.

The inlet and/or outlet of the cooling medium require an opening to be created from the inner region of the piston towards the cooling gallery or the cooling chamber. For this purpose, it is known in principle for a main piston body, e.g. a piston blank, to be produced which comprises the cooling gallery or the cooling chamber, wherein at least one bore is then introduced from the inner region of the main piston body towards the cooling gallery or the cooling chamber. Once the at least one bore has been introduced, the cooling gallery or the cooling chamber becomes accessible.

The problem addressed by the invention is therefore that of improving a gallery-cooled piston of the kind described above, such that the disadvantages which have been described are removed and an improved gallery-cooled piston is supplied.

The problem is solved according to the invention in that a funnel-shaped tube is inserted and fixed in the at least one opening after the gallery-cooled piston has been produced. The funnel-shaped tube is therefore inserted in the opening which extends from the inner region of the main piston body into the ring-shaped cooling gallery or cooling chamber, which has already been produced, once the gallery-cooled piston has been produced.

In this case, the funnel-shaped tube can be pressed into the opening. However, it can also be fixed in the opening by means of a snap-on connection. Furthermore, it is possible for the funnel-shaped tube to be fastened in the opening by a joining connection, e.g. by welding.

The at least one opening into which the funnel-shaped tube is to be inserted can be introduced during production of the piston blank, or also following production thereof. This opening can be introduced from the inner region of the piston blank towards the cooling gallery, or the cooling chamber, for example by casting and subsequent rinsing, but also just as effectively by machining, e.g. drilling, milling, or the like, or by other suitable methods. The geometric shape of this opening is cylindrical, for example. However, it may also have other geometric shapes, e.g. a cone shape, wherein the diameter of the cone, starting in the inner region of the piston blank, becomes smaller towards the entrance of the opening into the cooling gallery or the cooling chamber.

The funnel-shaped tube, which has been produced and prepared separately from the piston blank, is inserted into this prepared at least one opening in said piston blank. It is firstly conceivable for this tube to be fixed in the opening by an interference fit. However, it is also conceivable for the tube to be fixed in the opening by a joining method such as welding, for example, as an addition or alternative to the interference fit. Moreover, it can likewise be fixed in the opening by form-fitting, for example a snap-on connection, as an addition or alternative to the two methods referred to above. There are multiple variants when it comes to the axial extent of the funnel-shaped tube. The length of the tube either corresponds to the length of the opening in the piston, which means that the end of the tube in each case terminates with the inner region of the piston blank or the entrance of the opening into the cooling gallery or cooling chamber. Alternatively, it is conceivable for the tube to project slightly into the cooling gallery, or the cooling chamber, and/or to protrude beyond the surface of the inner region of the piston blank. If the tube protrudes slightly into the cooling gallery, a banking is advantageously formed around the inlet region of the opening in the cooling gallery or the cooling chamber, which banking causes cooling medium, e.g. oil, to accumulate on the floor of the cooling gallery or cooling chamber, at least when the piston, which has been finished and is ready for use, is at a standstill in the cylinder chamber of the internal combustion engine. This effect helps improve the cooling effect of the cooling medium circulating in the cooling gallery, even when there is an oscillating movement of the cooling gallery which is ready for use in the internal combustion engine.

The funnel shape of the tube, the diameter of which is greater in the inner region of the gallery-cooled piston than in the outlet region which points to the cooling gallery or cooling chamber, has the advantage that a free jet of cooling medium, in particular of cooling oil, which is delivered by a spray nozzle towards the underside of the inner region of the gallery-cooled piston during its operation in the internal combustion engine, is ideally introduced during the entire upwards and downwards movement of the gallery-cooled piston, but in a wide range of this movement, via the funnel-shaped tube into the cooling gallery or cooling chamber. Moreover, component tolerances and tolerances during assembly of those elements involved in the cooling of the cooling gallery, e.g. the arrangement of the spray nozzle, orientation of the gallery-cooled piston in the cylinders of the internal combustion engine, etc., can be balanced.

### BRIEF DESCRIPTION OF THE DRAWINGS

Exemplary embodiments of the invention are shown in simplified form in the drawings. In the drawings:

FIG. 1 is a perspective view of a funnel-shaped tube;

FIG. 2 is a cross-sectional view taken along line A-A in FIG. 5.

FIG. 3 is a front view of the funnel-shaped tube in FIG. 1.

FIG. 4 is a cross-sectional view taken along line B-B in FIG. 3.

FIG. 5 is a rotated top view of FIG. 3.

FIG. 6 is a bottom view of FIG. 3.

FIG. 7 is a front view of a gallery-cooled piston.

FIG. 8 is a bottom view of the gallery-cooled piston in FIG. 7.

FIG. 9 is a cross-sectional view taken along line C-C in FIG. 8.

FIG. 10 is a rotated cross-sectional view taken along line D-D in FIG. 8.

### DETAILED DESCRIPTION

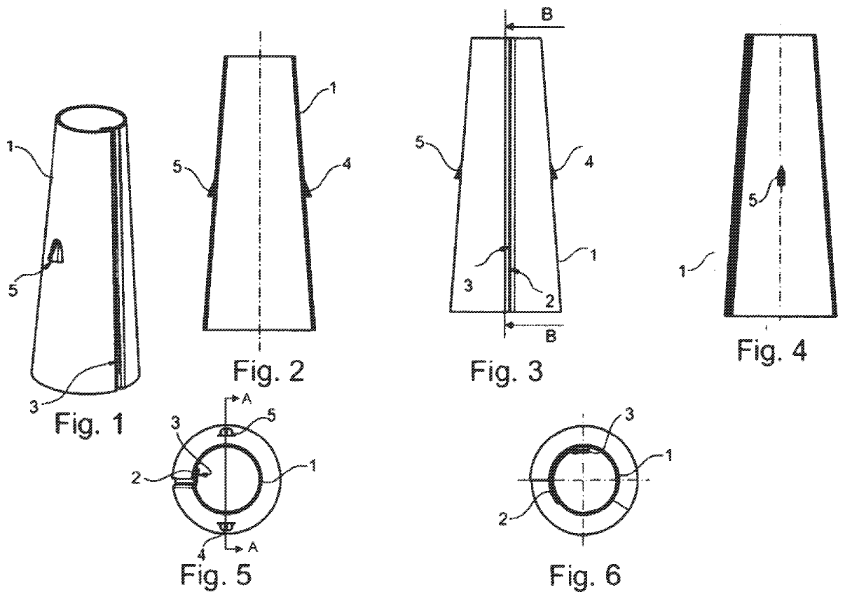

In FIGS. 1 to 6 the funnel-shaped tube which is produced separately from the main piston body, in particular the piston blank, is designated 1 and depicted in multiple views and in two sections. The funnel-shaped tube 1 is produced from a suitable sheet metal material, for example, by a rolling process. The joint edges designated 2 and 3 can be arranged in an overlapping or abutting manner in this case. In both cases, either a joining process for connecting the two joint edges 2 and 3 can be omitted, or it can take place point by point, in sections, or over the entire length. In the exemplary embodiment according to FIGS. 1 to 6, the joint edges 2 and 3 overlap, a joining process for connecting the two joint edges 2 and 3 being omitted. Two projecting latching lugs 4 and 5 are provided roughly in the center of the longitudinal extent of the funnel-shaped tube 1. The two latching lugs 4 and 5 are diametrically opposite one another in this exemplary embodiment. More than two latching lugs, or similar, can of course also be provided over the circumference of the funnel-shaped tube 1 and/or the axial extent thereof. Recesses which preferably have a ring-shaped design and which are assigned to the latching lugs 4 and 5 can be provided in the opening of the gallery-cooled piston. By means of these latching means, in particular latching lugs 4, 5, or similar, the funnel-shaped tube 1 is inserted in the opening in the piston blank, which opening may be cylindrical or have another shape, e.g. conical, and fastened there. The funnel-shaped tube 1 can also be fixed by a joining method, e.g. spot welding or continuous welding, by an adhesive process, or similar. The latching means, in particular the latching lugs 4 and 5, moreover cause the funnel-shaped tube 1 to be fixed in the opening in the piston blank in such a manner that said funnel-shaped tube 1 can no longer move from the opening into the inner region of the gallery-cooled piston.

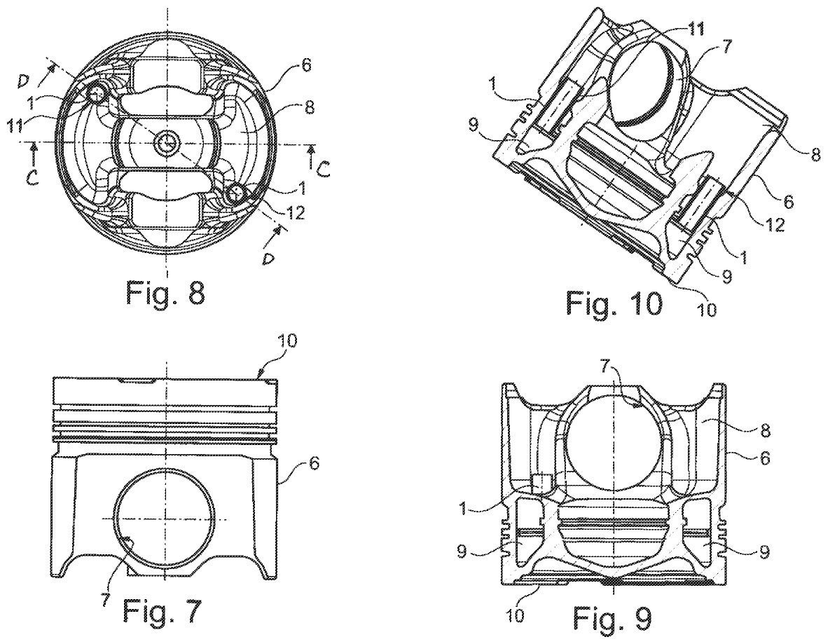

The gallery-cooled piston shown in FIGS. 7 to 10 is designated 6. The gallery-cooled piston 6 has bolt bores 7, via which it is connected to a connection rod of the internal combustion engine (not shown). The bolt bores 7 are arranged in the wall of the inner region 8 of the gallery-cooled piston 6. A cooling gallery 9, which extends as far as the piston crown 10, is attached to the inner region 8. Two openings 11, 12 in which funnel-shaped tubes 1 are inserted and fixed in accordance with the previously described measures are provided between the cooling gallery 9 and the inner region 8 of the gallery-cooled piston 6.

The tubes 1 are depicted in cylindrical-shaped form in FIGS. 8 and 10. However, they are actually funnel-shaped tubes, or corresponding variations, which may also be in the shape of a cone or truncated cone.

### LIST OF REFERENCE SIGNS

1 funnel-shaped tube
2, 3 joint edges
4, 5 latching lugs
6 gallery-cooled piston
7 bolt bore
8 inner region
9 cooling gallery
10 piston crown
11, 12 openings

1. A gallery-cooled piston having a cooling gallery positioned in the region of a piston crown the gallery-cooled piston defining at least one opening extending from an inner region of the gallery-cooled piston to the cooling gallery and having a funnel-shaped inlet, characterized in that a funnel-shaped tube is inserted and fixed in the at least one opening after the gallery-cooled piston has been produced.

2. The gallery-cooled piston of claim 1, characterized in that the funnel-shaped tube is pressed into the at least one opening.

3. The gallery-cooled piston of claim 1, characterized in that the funnel-shaped tube is fixed in the at least one opening by a snap-on connection.

4. The gallery-cooled piston of claim 1, characterized in that the funnel-shaped tube is fixed in the at least one opening by welding.

5. The gallery-cooled piston of claim 1, characterized in that the funnel-shaped tube axially projects beyond an entrance region of the at least one opening into the cooling gallery.

6. A method for producing a funnel-shaped tube for use in the gallery-cooled piston of claim 1, characterized in that the funnel-shaped tube is produced by rolling a sheet metal material which has been cut to size.

7. The method of claim 6, characterized in that after rolling, joint edges of the funnel-shaped tube are fastened to one another by a joining process point by point or in sections or over an entire length of the joint edges.

8. The method of claim 7, characterized in that after rolling, the joint edges of the funnel-shaped tube are arranged in an overlapping manner.

9. The gallery-cooled piston of claim 1, characterized in that latching lugs are formed in a wall of the funnel-shaped tube.

10. The gallery-cooled piston of claim 2, characterized in that the funnel-shaped tube is fixed in the at least one opening by welding.

11. A gallery-cooled piston for use in an internal combustion engine comprising:
a piston crown defining a cooling gallery and an inner region, the piston crown defining at least one opening in communication with the cooling gallery and the inner region; and
a funnel-shaped tube axially positioned in the at least one opening and fixed to the piston crown, the funnel-shaped tube operable to allow a cooling medium to pass between the cooling gallery and the inner region.

12. The piston of claim 11 wherein the funnel-shaped tube further comprises:
a single piece of sheet material having joint edges connected to one another to form the funnel shaped tube.

13. The piston of claim 12 wherein the funnel-shaped tube joint edges are connected together by welding.

14. The piston of claim 11 wherein the funnel-shaped tube further comprises a pair of latching lugs formed in a circumferential wall of the funnel-shaped tube, the latching lugs extending radially outward from a longitudinal axis of the funnel-shaped tube.

15. The piston of claim 14 wherein the latching lugs are positioned diametrically opposite one another.

16. The piston of claim 15 wherein the funnel-shaped tube includes a length between opposite ends of the funnel-shaped tube, the latching lugs are positioned at a mid-point along the length between the opposite ends.

17. The piston of claim 15 wherein the at least one opening further defines recesses positioned to receive the respective latching lugs through the recesses to fix the funnel-shaped tube to the piston crown.

18. The piston of claim 11 wherein the funnel-shaped tube includes a first end an opposite second end, the funnel-shaped tube is positioned and fixed to the piston crown having the first end extending axially into the cooling gallery.

19. The piston of claim 18 wherein the piston crown further comprises a banking region extending into the cooling gallery around the at least one opening.

20. The piston of claim 18 wherein the funnel-shaped tube second end axially extends into the interior region.
